(19) United States
(12) Patent Application Publication
(10) Pub. No.: US 2021/0329320 A1
(43) Pub. Date: Oct. 21, 2021

(54) SYSTEM FOR PERSONALIZATION OF ADVERTISEMENT PERSONAS USING SOCIAL AFFINITY UNDERSTANDING

(71) Applicant: AT&T Intellectual Property I, L.P., Atlanta, GA (US)

(72) Inventors: Paul Triantafyllou, Summit, NJ (US); David Crawford Gibbon, Lincroft, NJ (US); Jean-Francois Paiement, Sausalito, CA (US); Jianxiong Dong, Pleasanton, CA (US); Eric Zavesky, Austin, TX (US)

(73) Assignee: AT&T Intellectual Property I, L.P., Atlanta, GA (US)

(21) Appl. No.: 16/850,667

(22) Filed: Apr. 16, 2020

(51) Int. Cl. H04N 21/2668; H04N 21/258; H04N 21/81; H04N 21/234

(52) U.S. Cl. CPC H04N 21/2668; H04N 21/23424; H04N 21/812; H04N 21/25866

(57) ABSTRACT

Aspects of the subject disclosure may include, for example, receiving, by a processing system including a processor, a request for personalized media content for presentation on a user device of a user, selecting, from an anchor media marketplace, an anchor media item such as a video item, an audio item or an image, for the personalized media content, retrieving information defining a derived persona of the user, personalizing the anchor media item according to the derived persona of the user, forming a personalized media item, and presenting the personalized media item to the user device of the user. The presenting is substantially in real time with receiving the request for the personalized media content. Other embodiments are disclosed.

### FIELD OF THE DISCLOSURE

The subject disclosure relates to a system for personalization of advertisement personas using social affinity understanding.

### BACKGROUND

Artificial Intelligence has been used to create appearances of individuals' faces in artificial contexts.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a functional block diagram illustrating an example, non-limiting embodiment of a system for personalization of advertisement personas using understanding of social affinity functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for personalizing advertising content for particular consumers. Existing media are modified and personalized based on consumer-specific information to improve the affinity or appeal of a content item such as a video item, audio item or image for the consumer. One or more embodiments can apply various techniques described herein according to authorization or permission of users. Other embodiments are described in the subject disclosure.

One or more aspects of the subject disclosure include features of receiving an anchor media item, receiving social network information of a user, and creating a profile for the user based on the social network information of the user. The subject disclosure further includes features of modifying the anchor media item using the profile for the user to personalize the anchor media item for the user, forming a personalized media item and presenting the personalized media item over a network to a user device associated with the user. The subject disclosure further includes features of detecting a response to the personalized media item by the user after presenting the personalized media item to the user and updating the profile for the user responsive to detecting the response.

One or more aspects of the subject disclosure include features of receiving, by a processing system including a processor, a request for personalized media content for presentation on a user device of a user and selecting from an anchor media marketplace an anchor media item for the personalized media content. The subject disclosure further includes features of retrieving information defining a derived persona of the user, personalizing the anchor media item according to the derived persona of the user, forming a personalized media item and presenting the personalized media item to the user device of the user. In some embodiments, the presenting may be substantially in real time with the receiving the request for the personalized media content.

One or more aspects of the subject disclosure include storing, in an anchor data marketplace, content items for modification to create personalized content items, receiving a request for a personalized content item to be provided to a user device of a user and selecting, from the anchor data marketplace a selected content item. The subject disclosure further includes features of determining one or more constraints for the selected content item, where the one or more constraints limit use or reuse of the selected content item, and comparing the one or more constraints for the selected content item with the request for the personalized content item. The subject disclosure further includes features of modifying the selected content item if the selected content item is usable according to the one or more constraints. The modifying the selected content item may include personalizing the selected content item according to stored personalization information of the user to produce the personalized content item. The subject disclosure further includes features of providing the personalized content item to the user device of the user.

Techniques to modify visual and other media items are used to create convincing but synthetic images, audio and video items. These techniques may be adapted to modify content such as advertising and to make the content be more appealing to a person who sees or hears the adapted content.

Improving affinity of content such as advertising has been done in various ways, particularly by identifying viewer demographics and matching those to the extent possible. Advertising on a sports programming network will be adapted to viewers in demographic groups who prefer viewing such sports.

There exist for people in societies certain social constructs with which individuals are more familiar. Such social constructs may relate to appearance, such as fashion or ethnicity. Such social constructs may be audible in nature, such as language, dialect, accent or tone of voice, or musical styles. Such social constructs may be functional and relate to activities such as sports or a workplace or city environments or rural environments. By adapting media items according to social constructs with which a consumer of the media items is familiar or comfortable, the media items may be experienced more favorably.

With the increasing personalization of content and advertisements, the need to have a direct connection to the actors, place, and activity is a strong requirement for engagement with an advertisement or with the advertised product. Modern methods that directly apply images or likenesses of social connections, such as friends, family, etc., for direct endorsements are often weak in nature and often dismissed by the recipient. Examples of this include linking of a product review, a like action on social media, etc. Similarly, the inclusion of classical affinity descriptions such as beauty, trust, etc., may be too generic to find a likeness of an actor or their actions to sufficiently engage a user. In both cases, modern techniques for face generation currently lack a connection to these rich descriptions of characteristics and appearances that are preferred by a user. Thus, the combination of such modern generative methods with awareness of consumers' social constructs creates new opportunities for personalization of advertising creatives.

For example, a review of social media and other online activities of an individual will provide information about appearances and activities of contacts of the individual. Pictures of the contacts may be viewed on social media and activities may be reported, along with locations visited, clothes worn, and other information. Such information could be used to personalize advertising seen by the individual. For example, if social media activities reveal the individual has five close friends, advertisements could be customized to show a group of that size. The advertisements may be customized so that they can track individuals with the desired track characteristics such as demographics of the group members. If two group members wear beards, advertisements could be customized accordingly. The individuals may not be exact duplicates of the friends, but by showing that similar people doing familiar things, such advertisements create a stronger affinity for the individual. They help the individual see himself or herself buying the advertised product.

Currently, different versions of advertisements may be created for different audiences to try to match demographics or other appearance aspects of the different audiences. A version of an advertisement is created for a California audience with California visual cues. A different version of the advertisement is likewise created for a Midwestern audience, with Midwestern visual cues. The respective versions of the advertisement may be shown in their respective regions to thereby create a degree of affinity with the respective audiences. However, each version is static. Once the advertisement is designed and produced, it is unchangeable and only coarsely targets the specific audience. Further, creating each specific version of an advertisement is relatively expensive and the cost is relatively fixed.

In contrast, use of artificial intelligence and information about particular viewers based on, for example, social media data, creates new opportunities for finer targeting of an advertisement to a specific viewer. By using available information, a much higher degree of affinity creation, at near real-time, is possible. This is done as a viewer-specific version of the ad is created and displayed. The viewer specific version can be based on the information that is currently available for the user. In some examples, referred to as cold start where minimal information such as just demographics and location is available, the advertisement may have only a relatively low level of personalization. On the other hand, if substantial data has been mined for the individual, including social media data, past purchase data, etc., a much higher degree of personalization may be built into the advertisement for that individual. And the personalization is relatively low-cost since the personalization is done automatically, for each viewer, using artificial intelligence on user data of the viewer.

Application of artificial intelligence to the problem of creation of content including advertising permits creation of new media targeted at a particular viewer. For example, as noted, visual appearances can be customized to the viewer based on demographic information, geographic information, behavioral information and psychographic information for the user. Moreover, audio information can be created on the same basis as well. Thus, a virtually created character in an advertisement can be modified or created to appear to speak a particular script or other text that is prepared by the advertiser to deliver a message.

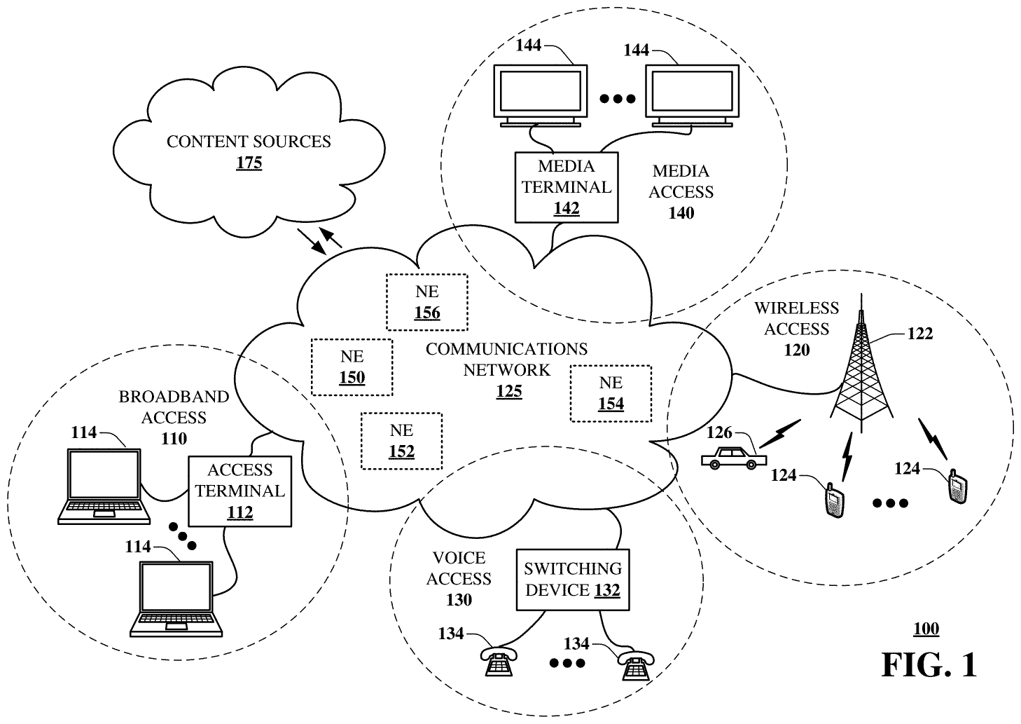

Referring now to FIG. 1, a block diagram is shown illustrating an example, non-limiting embodiment of a system 100 in accordance with various aspects described herein. For example, system 100 can facilitate in whole or in part personalizing content items such as advertisements for presentation to a user, based on social content and other online information of the user. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

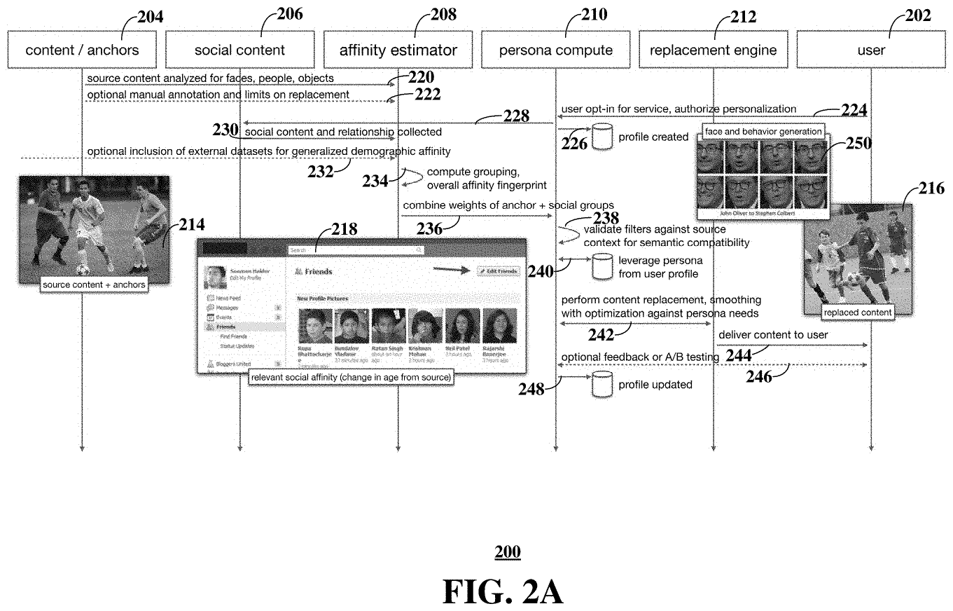

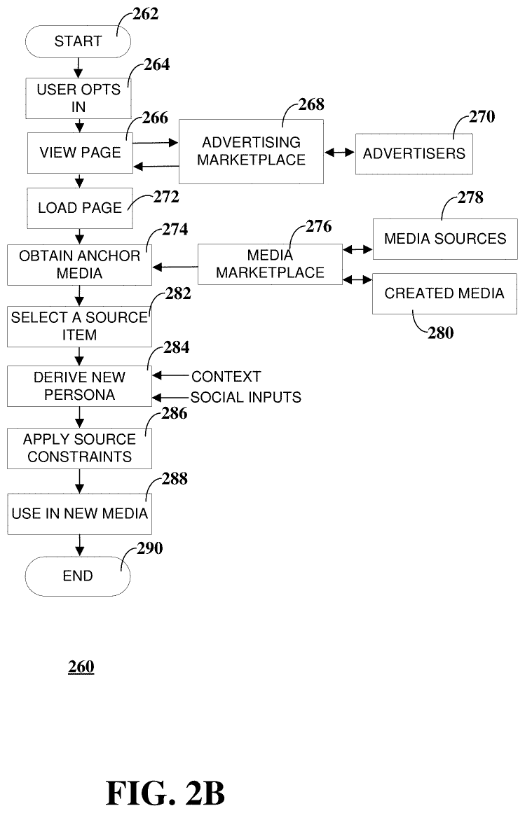

FIG. 2A is a functional block diagram illustrating an example, non-limiting embodiment of a system 200 for personalization of advertisement personas using understanding of social affinity functioning within the communication network of FIG. 1 in accordance with various aspects described herein. The system 200 in the exemplary embodiment includes a series of functional blocks and stored data that operate in conjunction with a user device 202. The functional blocks in this example include a source content/anchor data marketplace 204, a social content repository 206, an affinity estimator 208, a persona process 210, and a replacement engine 212. FIG. 2A illustrates an example of communications about the illustrated components.

The user device 202 may be any network device operable, for example, in the communication network 125 of FIG. 1, such as data terminals 114 or access terminal 112, media terminal 142, audio/video display devices 144, a mobile device such as mobile devices 124. The user device 202 may be suitable for or adapted for receipt and consumption of media content, including video content, image content, audio content and others. The user device may access content from any appropriate content source such as content sources 175 of audio, video, graphics, text and/or other media as illustrated in FIG. 1. The user device may access such media content in any suitable manner, including broadcast television, access over one or more private networks such as a cable TV network, access over one or more public networks such as the internet, and over wireless and wire line networks. In specific, non-limiting examples, the user device 202 may be a set-top box, a smart television or other addressable television device, a mobile telephone, a tablet computer or laptop computer, or a software component such as an application or app operating on a device such as a mobile device or smart television.

The source content/anchor data marketplace 204 stores content items that may be provided to the user device 202. The source content/anchor data marketplace 204 may be implemented as a data processing system including a processor and a memory accessible over a network such as the internet. The stored content items may be referred to as baseline media or anchor data. Anchor data or anchor media items are content items or media items that are suitable for modification and adaptation in accordance with embodiments described herein for presentation as a relevant marketing message at one or more user devices such as user device 202. The content items stored in the source content/anchor data marketplace 204 may be generic content items or may be custom content items. A generic content item is generally a preexisting content item available to be modified for use in a marketing message without re-creating the source content item. In conventional systems, a content item developed for a specific purpose such as a marketing campaign can only be adapted to another usage by re-shooting or re-recording the source content item. Embodiments in accordance with features described herein obviate the need to recreate a content item. One example is a video of a crowd scene that can be automatically personalized with people that generate affinity in a user of the user device 202. Another example is a previously recorded message that may be adapted or personalized for a current marketing message. A custom content item is an item of content specifically recorded for use in a current marketing message and that is adaptable or may be automatically personalized in a way to generate affinity in a marketing message.

The source content/anchor data marketplace 204 may operate as a marketplace where baseline media or anchor data may be provided by creators of content and may be selectable by providers of marketing for modification, adaptation or personalization. For example, an advertising creator may have an inventory of pre-existing television commercials. The commercials may be in the form of video or audio segments, or images, any of which may be adapted or personalized by artificial processing to form a custom marketing message. The commercials may be characterized according to product type displayed in the commercials, such as sporting goods or home electronics. The commercials may be characterized by persons appearing in the commercials, such as family members or teenagers or young children. Any suitable characterization may be made and may in turn by used to offer and accept the commercials by a provider and a marketer in the source content/anchor data marketplace 204. In exchange for buying a commercial for modification, the marketer may offer any suitable consideration to the creator, such as money payments.

The pre-existing commercials or other content items are available for personalization by a marketer, using information about the user associated with the user device 202. In this way, the marketer can derive a new persona that is specific to the user associated with the user device. For example, the derived persona may be a combination of the user's friends on social media. The derived persona does not really exist but can be used by the system 200 as a consistent replacement across different sources. Thus, the baseline media or anchor data may be reused by different marketers. Also, the derived persona may be reused by a marketer for different contexts, campaigns or products.

In the source content/anchor data marketplace 204, a content creator may specify semantic constraints for the generation, use, and reuse of content items. A marketer selecting an offered content item in the source content/anchor data marketplace 204 takes the selected content item subject to any constraints imposed by the creator or others involved in the marketplace or in the creation of the content items. Example constraints may limit the products with which a content item can be used or the frequency with which a content item can be reused. For example, such semantic constraints may seek to avoid abuse and contradictory specification from the content creator's original intent. In one embodiment, when a request for an anchor media item is received, the request may specify a planned usage for the anchor media item. For example, the request may specify a product which is to be advertised, types of modification and personalization to be made, and so forth. The constraints for respective anchor media items in the source content/anchor data marketplace may be compared with information of the request to determine if a particular anchor media item may be used without violating the constraints. If so, the anchor media item may be modified and personalized for the user. If constraints will be violated, another anchor media item without the same constraints may be selected.

The source content/anchor data marketplace 204 provides technical benefits for marketers seeking to provide marketing messages or any type of content to a viewer. For example, the source content/anchor data marketplace 204 makes available for use and reuse existing content which may be personalized for the marketer's target audience and purpose. This reduces the time necessary to generate the personalized content item.

In some embodiments, anchor content from the source content/anchor data marketplace 204 can be personalized for presentation to the user device in near real-time. For example, as the user views content such as a television program or a web page on the user device 202, the viewing may generate an ad call for an advertising item to be created and presented on the user device. In response to the ad call, a baseline media item such as a preexisting commercial may be automatically selected from the source content/anchor data marketplace 204, automatically personalized according to a derived persona for the user associated with the user device 202 and conveyed to the user device 202. This can be done in near real-time, automatically, as the user is viewing content such as a television program on the user device. In this example, near real-time may be defined to be a time duration so short that it is not substantially perceptible by the user viewing content on the user device. The time duration may be up to a second or two from the time an ad call is generated to display the personalized content item to the user. The personalized content can be instantly tailored to the television being viewed without need to shoot a custom commercial or multiple versions of a custom commercial. There is no need to re-shoot all or a portion of the commercial. This reduces the cost and the time to prepare the personalized content by the marketer. Further, the derived persona can be reused on subsequent occasions, for other advertising purposes, and with other baseline media items.

Further, the system 200 allows social affinity to be programmatically derived from the user's social data, after the user opts in to the system 200. This can augment traditional psychological and sociological preferences of viewers and other content consumers. In this way, marketers can help build affinity between the user and the message or the product advertised. This can improve the performance of the advertising for the marketer and help the viewer to see or hear advertising that is most relevant and useful to the viewer.

In the example of FIG. 2A, a content item 214 is retrieved from the source content/anchor data marketplace 204. In this example, the content item 214 shows three teenage boys playing soccer, each wearing different clothing and shoes. The content item 214 may be a video portion or a single image. It may include audio content as well. The content item 214 is a baseline media item or anchor data that may be personalized by artificial intelligence by inserting one or more derived personas into the content item 214 for presentation on the user device 202. The content item 214 is a preexisting content item such as a commercial. The content item 214 is personalized by the system 200 by, for example, mapping into the content item one or two or three derived personas that are based on, for example, social media friends of the user associated with the user device 202.

After personalization, the content item 214 may be presented as personalized content item 216 for display on the user device 202. The personalized content item 216 may be presented on the user device 202 as a video commercial with background audio. The video commercial as personalized for the user may show three young boys playing soccer in matching team uniforms and with shoes of a particular brand that is the subject of the marketing message of the personalized content item 216. The appearance of the personalized content item 216 including the faces of the boys, their clothing and shoes and other visual aspects, may be modified from the baseline media item 214 to generate increased affinity for the user. Further, the background audio may include spoken content. The spoken content may be generated by artificial intelligence to match or resemble a voice or tone or inflection or an accent or a language of one or more derived personas based on social media friends of the user.

In another example, the personalized content item 216 may be presented on the user device 202 as a still image in association with, for example, a news story or a blog post. The baseline media item 214 may be modified to produce the personalized content item 216 by using information about the user associated with the user device 202. Again, in the still image as in the video content, the content item 214 is presented with derived personas to generate affinity between the user and a product advertised.

In another example, the personalized content item 216 may be created at a remote device at the cloud level from the baseline media item 214 and downloaded to the user device 202 without immediately presenting the personalized content item 216. The personalized content item 216 may be stored for a time at the user device 202 and presented at a suitable time while the user associated with the user device 202 is viewing other content. As an example, the user device 202 may include a set top box or addressable television device. The system 200 in some embodiments will pre-load advertisements including the personalized content item 216 before the actual viewing. As the user is viewing a program or other content, the advertisements including the personalized content item 216 may be displayed for the user to view.

The social content repository 206 stores user information about users including the user associated with the user device 202. The social content repository 206 may typically be contained in a data processing system including a processor and a memory and accessible over a network such as the internet. The user information may be obtained from any available source. One possible source of user information is social media activity of the user and acquaintances of the user, such as the user's Facebook friends listings 218. Some social media websites and applications (or apps) monitor and record activity of an individual including relationships with online friends. Such monitored activity may include social media postings that the user views and approves, for example, by clicking a Like link, and comments made on social media by the user, including a positive or negative tone of the comments. Such social media information may be stored in memory such as a database forming the social content repository 206. Another possible source of user information is online activity of the user. Online activity may include pages viewed and information about the content of those pages, advertisements viewed and additional activity related to advertisements, such as clickthroughs for more information and purchases made. Other online activity may include statistical information such as the dwell time during which the user viewed particular page or advertisement. Other online activity, such as selecting and viewing content items or using particular apps such as a mapping app, may be monitored and stored as well in the social content repository 206.

Still further, if the system 200 has access to other media consumption information of the user, that information may be processed and stored as well. Examples include television programs or movies or other video content viewed, music requested or heard, radio programs heard, and any recorded reactions to such media. Thus, the social content repository 206 may collect, store and process the widest range of information about the user. Generally, this information may include demographic, geographic, behavioral and psychographic information. The collected and processed information may be used to determine interests and preferences of the individual.

The affinity estimator 208 operates to determine relative affinities of users including the user associated with the user device 202. The affinity estimator 208 may be implemented in a processing system including a processor and a memory and accessible over a network such as the internet. The affinity estimator 208 may implement a machine learning model. In one example, the affinity estimator 208 maps to a space anchor media items from the source content/anchor data marketplace 204 and maps to the space interests of users based on the users' social profile determined from the social content repository. The affinity estimator 208 then determines the relative closeness of a user in the space and an anchor media item as an estimation of the affinity of the user for the anchor media item or the degree to which the anchor media item is applicable to the user.

In one embodiment, the affinity estimator 208 implements a neural embedding model. The embedding may be created from the content of anchor media items in the source content/anchor data marketplace 204. Items of video or audio or images may be converted into an embeddings vector or a series of numbers in a Cartesian or other multidimensional space. Each content item is represented as a vector in the multidimensional space. Based on this conversion, if two items are relatively close to each other in the space, then they may be considered to be relatively close to each other in a semantic sense. For example, two video items showing people playing soccer will be relatively close together, using the Euclidean distance between the two points in the Cartesian space. In contrast, two content items that have little relationship, such as a video of soccer players and a video of a lumberjack in the forest, will be relatively farther apart. Thus, every piece of content from the source content/anchor data marketplace 204 may be represented by a point in the space where distance is meaningful in terms of semantic closeness. The embedding of the content provides the machine learning model for determining a relative affinity between a user and content items.

The persona process 210 operates to estimate an online persona or profile for a user for presentation in modified content such as personalized content item 216. In some embodiments, the persona process 210 may operate as an offline or background process. In other embodiments, the persona process 210 may operate substantially in real time. For example, a plurality of descriptors may be detected and stored for the user based on information for the user in the social content repository 206. Information of the persona process 210 will provide, for example, weights that control how an appearance of the user or social contacts of the user is changed to produce a personalized content item. Thus, the persona process 210 receives input information from anchor data of the source content/anchor data marketplace 204, online or spoken comments of the user, a social profile or expressed preferences of the user, etc. The profile or persona created by the persona process 210 may be persistent over time for subsequent use, modification and updating. The profile may also be used for a cold start situation, where the system 200 begins monitoring media consumption activities of the user but has little initial information about user preferences. Until user activities have been collected and monitored to update the user's persona, the profile produced by the persona function may be used to targeting personalized content including advertisements to the user.

The replacement engine 212 operates to modify an anchor media item to form a personalized media item. The replacement engine 212 uses a machine learning model to modify the anchor media item, such as baseline media item 214, to produce the personalized content item 216. The persona generated by the persona process 210 is artificially and automatically inserted into the baseline media item. In one embodiment, the replacement engine 212 implements a face and behavior generation process 250. For example, one face can be mapped to another face, where two characters are in substantially the same pose and, in the illustrated example, the character in the upper images may be modified to appear as the character in the lower images by pixel modification. The replacement engine 212 may map a face from the profile 226 of the user to an anchor media item to personalize the anchor media item for the user. In some embodiments, the face mapped to the anchor media item may be the face, or a version of the face of the user. In other embodiments, the persona process 210 may compute a persona or profile for the user in which the personal has a face that is a composite of faces of online acquaintances of the user, such as the user's Facebook friends 218. The effect of the modification to the anchor media is to increase the affinity of the user for the anchor media item and any product advertised there. Because the user recognizes faces that look like the user's own, or the user's friends and acquaintances, the user feels greater affinity for the anchor media or product advertised there.

The replacement engine 212 in some embodiments may be implemented in a processing system including a processor and a memory and accessible over a network such as the internet. In such an embodiment, the replacement engine 212 may be located in a cloud device and communicate with other devices such as the persona process 210 and the user by means of the internet. In other embodiments, the replacement engine may be implemented on the user device 202. For example, the replacement engine 212 may be implemented as an application or app on the user device 202. Thus, in applications where the user device includes a smart television or mobile device such as a radiotelephone, the user device includes a software application that implements the replacement engine and communicates with the persona process 210 to provide content such as the personalized content item 216 for viewing by the user. In some embodiments, multiple content items such as baseline media item 214 may be provided to the user device 202 for processing by the user device according to persona information provided to the user device and replacement engine 212 to produce multiple personalized content items such as the personalized content item 214. The multiple personalized content items may be stored at the user device 202 and displayed to the user as the user watches a program or other video content on the user device.

In some embodiments, the replacement engine 212 may be implemented as a probabilistic model or neural network for artificial intelligence. In one embodiment, then, the persona process 210 may include latent variables that represent the user and the context such as information about close friends of the user, what the user reacted to, what the user viewed in the past. The machine learning model can use the information of the persona process 210 to drive the replacement engine according to the latent variables and make the decision to replace the contents of a baseline media item 214 to produce the personalized content item 216.

In an example of operation of the system 200, a parent may be online browsing a website using a laptop computer, for example. The parent may be a user associated with a user device such as user device 202. The parent may be a user who has opted into the use of the system 200 for providing content items to the user. The opt-in process gives user permission to access personal information of the user, traverse the user's social graph and process the user's data to, for example, form a profile for the user for providing content items.

The parent may be a user for whom a profile has been established by the persona function. The website viewed by the parent tracks the parent's browsing interest and has information that, for example, the parent has children who like soccer. The website contacts over a network such as the internet the system 200 which has source content/anchor data marketplace 204 and social content repository 206. The source content/anchor data marketplace 204 includes images and media showing sports available for advertisements. This includes the baseline media item 214 showing teenagers playing soccer. Since the website has been tracking online activities of the parent and the parent's device, there is information about the parent's online social context available in the social content repository 206.

In addition, the system 200 has advertiser clients who have advertisements or other content they desire to show to viewers such as the user. The advertisers and their advertisements may be part of a separate advertising marketplace in which impressions are received from viewers such as the user and an auction is conducted among advertisers having advertisements to fill the impressions. The results of the auction are used to select an advertisement to provide to the user device 202 to fill the impression. The advertisement of the advertiser is then used to modify the baseline media item 214 to produce the personalized content item 216 showing the advertised product. In the illustrated example, the advertised product maybe the soccer ball, the shoes the players are wearing or the uniforms the players are wearing, or other goods or services in which the user may have an interest.

In this example, the desired advertisement for this parent should have themes of sports-related, soccer and small children. The baseline media item 214 forms a content media anchor. The affinity estimator 208 and the replacement engine 212 will operate to morph or modify the baseline media item 214 showing teenagers into an item that will appeal to a parent of small children. The personalized content item 216 will be provided to the user device 202.

FIG. 2A illustrates exemplary operations of the system 200. Initially, step 220, source content items from the source content/anchor data marketplace 204 are provided to the affinity estimator 208. The source content items include anchor media items such as still images, video audio, and any other item that may be adapted for use in marketing or other usages. If the source content/anchor data marketplace 204 implements a marketplace for sharing, selecting and transferring content items, the source content items may include or be defined by constraints on their usage. The source content items are analyzed by the affinity estimator 208 to identify faces, people, objects, etc., and to characterize the items identified. For example, if a source content item shows a person playing soccer, the person may be characterized as male or female, according to age, and otherwise. Such characterization may be used for modification and personalizing the content items. Optionally, along with the source contents items provided at step 220, any available manual annotation or limits on replacement, such as semantic constraints, are provided to the affinity estimator 208 at step 222. For example, an advertiser or content owner providing a content item to the source content/anchor data marketplace 204 may pre-define elements or aspects of the content item or set semantic constraints on its use in order to better control or limit the use of the content item. The steps 220, 220 of collecting and analyzing source content items may be done in the background as an offline process, or as an ongoing process as new content items are added to the source content/anchor data marketplace 204.

At step 224, the user opts in to the service provided by the system. Requiring an affirmative opt-in may be important to preserve confidential information of the user and to give the user control over his information. The opt-in may be provided or received in any suitable way, such as by presenting information on a web page to the user and requiring that the user affirmatively agree to share personal information. The opt-in may specify, for example, that the user gives permission for collection of the user's social media information, browsing information, program viewing information, and others. The user's action to opt in is provided to the persona process 210, step 224, to enable generation of the user's persona. Responsive to user's action to opt in and the generation of the user's persona, a profile 226 for the user is created and stored, for example, in a database of user profiles. Further, the user's action to opt in is provided at step 228 to the social content repository 206 to enable collection and processing of the user's social presence.

Following the user's opt-in at step 228, social content and relationship information for the user is conveyed to the affinity estimator 208, step 230. The social content may include any suitable information collected by social media platforms accessed by the user. The social content may further include information about people having a relationship with the user, such as friends and acquaintances of the user, as well as interests shared with such people, web sites visited, information and items liked or disliked by the user, and so forth. The social content conveyed in step 230 may be limited the terms of any opt-in agreement made by the user.

At step 232, the affinity estimator 208 may receive any further information collected about the user, including pages viewed, preferences, products and services purchased, etc. Such information may be provided, for example, by search engines, advertisers or advertising marketplaces, or any other source that collects information about the user.

At step 234, the affinity estimator 208 computes for the user grouping information and an overall affinity fingerprint. The grouping information defines different groups with which the user has a particular affinity or shared interest. One group might include the user and friends who enjoy playing soccer. Another group might be the user and friends who are school classmates. Another group might include family members. Grouping may be done based on source data, such as the social context of user data. Grouping may also be done based on secondary classification tags, such as the face gender or a demographics classifier. The computed information may be stored at the affinity estimator 208 or at any suitable location accessible over a network such as the internet. The affinity estimator 208 may build a histogram and affinity model that characterizes user data.

At step 236, the weights of the anchor media from the source content/anchor data marketplace 204 and the social content are combined and conveyed to the persona process 210. The persona process may combine weighted versions of personalization. This may be done by basing similarity on demographics and history of the user, linked social content and user generated content. At step 238, the persona process 210 validates filters against the source context for semantic compatibility. The filters may be limitations on the use of a persona in an inappropriate context or where a conflict is created, such as detecting that a person is a surfer and, by means of a filter, preventing showing the person in an oil rig context, or not showing an underage minor in the context of an alcoholic beverage. Also, filtering may be based on application of constraints based on original content anchor semantics, such as not replacing a child's face with a grandparent's face. These constraints may be defined in conjunction with the original source content or through explicit annotations provided by the content creator. In some embodiments, localization filters may be applied to the persona. Also in some embodiments, the persona process 210 may use a historical profile specific to a user to recall or update an existing persona to be applied to the source or anchor media. At step 240, the persona process 210 leverages the stored persona for the user from the user profile.

At step 232, the persona process 210 and the replacement engine 212 perform a content replacement process. The baseline media item 214 received from the source content/anchor data marketplace 204 is modified according to the persona generated by the persona process 210 to produce the personalized content item 216 for display on the user device 202. For facial appearance and for audio, various techniques may be used to generate a face with different parameterized inputs. In some embodiments, the system can adapt movement and behaviors of elements of the anchor media to match that of social affinity content of the user. For example, if the social content reveals the user to be known to hop on one foot, to be always winking at others, to use hands when talking to an unusual degree, to have a particular accent or speech characteristic, any of these aspects may be used in generating the persona. To assist with visually integrating the persona into the anchor media, the replacement engine 212 may optically blend transitional regions between the added persona and the surrounding or adjacent anchor media. For example, the replacement engine may blur edges or transitional regions between an added face from the user's profile and the surrounding or adjacent anchor media to better visually integrate the added face with the adjacent images. This may be done as well by adjusting lighting, shadows, colors and by various acoustic effects as well. At step 244, the personalized content item 216 is delivered to the user device 202.

Following viewing of the personalized content item 216 on the user device 202, the system 200 may optionally collect feedback, step 246. For example, presenting the personalized content item to the user may be recorded as an impression at step 246. Further, if after seeing the personalized content item 216, the user clicked on a link to get more information or completed a transaction to buy a good or service, such actions may be tracked and stored for future use. If an impression, a click or a post-click action is detected or tracked, the user's profile may be updated, step 248. In another example, the system 200 may allow the user to explicitly choose the content source, either the anchor media that is used or the persona that is used to characterize the anchor media.

FIG. 2B depicts an illustrative embodiment of a method 260 in accordance with various aspects described herein. FIG. 2B illustrates a method for personalization of advertisement personas using social affinity understanding. The method 260 begins at block 262.

At block 264, a user of a system for personalizing advertisement personas opts in to participating in the system and method. Opting in my include agreeing to terms permitting collection and use of personal information including social network information of the user. Opting in may include signaling assent by accessing a specified web page and providing information.

At block 266, the user views a web page. The web page may be viewed on any suitable computing device such a laptop computer, a tablet computer or mobile device such as a radiotelephone. In other embodiments, in addition to or instead of a web page, the user may view a content item such as a video file or audio file on another type of user device such as a set top box or addressable television. In some way, at block 266, the user views or hears content provided over a network to the user.

The viewing of the content at block 266 causes an impression to be reported to an advertising marketplace 268. The advertising marketplace 268 is an online system for providing advertisements from advertisers 270 to users viewing content. The advertising marketplace receives impressions or opportunities to show advertisements to users. The impressions may be received from the users indirectly through publishers of content, not shown in FIG. 2B. The publishers provide content such as web pages, video programming, audio programming, etc., for consumption by viewers. The content may include one or more spots for advertisements and the opportunity to fill the one or more spots for advertisements may be referred to as impressions. Advertisers 270 may compete in the advertising marketplace 268 for the opportunity to fill the impressions presented to the advertising marketplace 268. In some embodiments, when an impression is received at the advertising marketplace, advertisers 270 bid for the opportunity to fill the advertisement with an advertisement. The bids may be based on information about the user associated with the impression, including demographic, geographic, behavioral and psychographic information about the user. If an advertiser has the highest bid, the advertisement for the advertiser will be selected and provide to the web page or other content item viewed by eh user at block 266. The page or other content item and one or more advertisements are provided when the page is loaded, block 272.

At block 274, one or more anchor media items are obtained from a media marketplace 276 to present on the page to the user. The selection of the anchor media items may be based on the advertiser returned from the advertising marketplace 268. Or, the anchor media item may be selected based on the advertiser associated with the returned advertisement. In this regard, there may be some communication, over a network or otherwise, between the advertising marketplace 268 and the media marketplace 276.

The media marketplace 276 stores content items that may be provided to the user. The media marketplace 276 may be implemented as a data processing system including a processor and a memory accessible over a network such as the internet. The stored content items may be referred to as anchor media or baseline media or anchor data. Anchor data are content items that are suitable for modification and adaptation in accordance with embodiments described herein for presentation as a relevant marketing message at one or more user devices. The media marketplace 276 may receive anchor media items from media sources 278, created media items 280, or any other suitable source. The media sources may be preexisting media items, such as a previously produced television commercial for a product. The preexisting media may be reused or repurposed for a new commercial by modifying or personalizing the preexisting media based on the characteristics of the user viewing the web page at block 266. Preexisting media items from the media sources 278 may have been created specifically for an advertising purpose or may have been created for another purposes. The created media items 280 may be created specifically for a marketing purpose, such as an advertising campaign. However, the created media items are also subject to a process or modification or personalization based on the characteristics of the user.

The anchor media and other content items stored in the media marketplace 276 may be generic content items or may be custom content items. A generic content item is generally a preexisting content item available to be modified for use in a marketing message without re-shooting or re-recording the source content item. One example is a video of a crowd scene that can be automatically personalized with people that generate affinity in a user. Another example is a previously-recorded message that may be adapted or personalized for a current marketing message. A custom content item is an item of content specifically recorded for use in a current marketing message and that is adaptable or may be automatically personalized in a way to generate affinity in a marketing message.

The media marketplace 276 may operate as a marketplace where baseline media or anchor media items may be provided by creators of content and may be selectable by providers of marketing for modification, adaptation or personalization. For example, an advertising creator may have an inventory of pre-existing television commercials. The commercials may be in the form of video or audio segments, or images, any of which may be adapted or personalized by artificial processing to form a custom marketing message. The commercials may be characterized according to product type displayed in the commercials, such as sporting goods or home electronics. The commercials may be characterized by persons appearing in the commercials, such as family members or teenagers or young children. Any suitable characterization may be made and may in turn by used to offer and accept the commercials by a provider and a marketer in the media marketplace 276. In exchange for buying a commercial for modification, the marketer may offer any suitable consideration to the creator, such as money payments.

At block 282, a media item received from the media marketplace is selected as the source item to be personalized for this user on this web page. At block 284, a new persona is derived for the user. As indicated in FIG. 2B, the information forming the basis of the new persona may come from a wide variety of sources. The sources include information about the current context which the user is viewing, such as the web page viewed at block 266, and the current location or activities of the user, such as commuting or reading at home. The sources forming the basis of the new persona, may also come from information about the user, such as information extracted from his social network, past web surfing activities, bookmarked pages, etc. Any reliable information may be used to derive the new persona at block 284. In some embodiments, the new persona may be derived offline at a previous time and stored for use at a time when the user is viewing the page at block 266. In other embodiments, the new persona may be derived essentially in real time, as the advertisement is prepared and personalized and presented on the page.

At block 286, any source constraints may be applied. Source constraints may be specified for the media item selected at block 282. Source constraints my limit the ways in which the media item may be used. For example, an advertiser associated with one brand may specify that the advertiser's product may not be shown with a competitor's product or logo. In another example, a creator of a created media item may specify that the created media item may not be shown in specified contexts such as with an advertisement for firearms or political messages. The application of the source constraints at block 286 may operate to change the way in which the selected source item is used or modified or personalized.

At block 288, the selected media item is applied or used in a new media item. For example, the selected media item may be personalized according to information of the user, such as the user's social media. In another example, the persona derived at block 284 may be used to personalize the selected media item. The method 260 ends at block 290.

In some embodiments, the system and method described herein may be used to create novel characters in a narrative. The video and audio may, in this way, be customized for each person. Some embodiments may include an operation to verify that a generated face is visually distant enough from all prior know faces created by the system. Such a feature could be used for anonymization of an event while still having a strong likeness to an original character. An example would be starting from a real video by using generation by machine learning model to create a new face. Similarly, some embodiments may include an operation to prevent generating content that is too similar to protected content, such as content protected by copyright or trademark protection, or such as brand or product similarity that is too close to an existing item.

The system and method in accordance with some embodiments provide for reusability of original source content for new, customized versions of content such as advertisements. This may be achieved without recapturing new content or assets for a different market, for example. Some embodiments provide for using artificial intelligence and machine learning of images or personal traits such as gender and age for social affinity as filters or tags for use in marketing. Embodiments can use the information of the user to learn and augment the social preferences of a user. Some embodiments use artificial intelligence and machine learning to determine details of an original anchor scene, to validate that context or semantics of the original scene is not violated by newly generated social entities. Examples include matching the age of the source and the potential social replacement. In some embodiments, through the creation of new personas that are unique to each user, that persona can now be reused via a user's profile in additional marketing or for specific narratives to establish a stronger familiarity with the user. Some embodiments allow for specification of a filter or a limit to be explicitly provided or automatically derived by coherence and semantic constraints.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

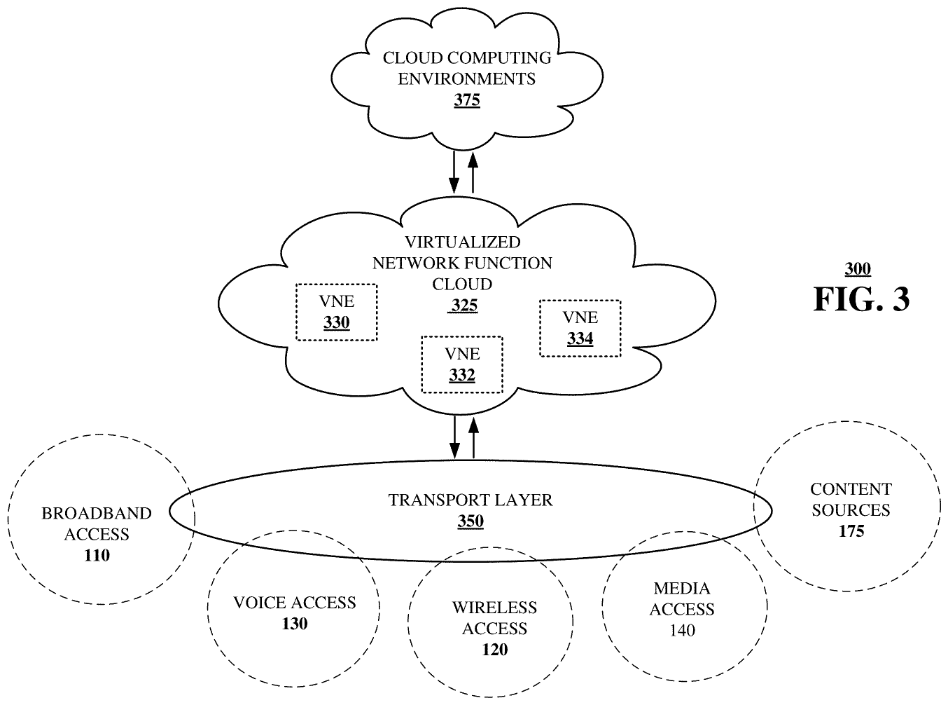

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 260 presented in FIGS. 1, 2A, 2B and 3. For example, virtualized communication network 300 can facilitate in whole or in part personalizing content items such as advertisements for presentation to a user, based on social content and other online information of the user.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

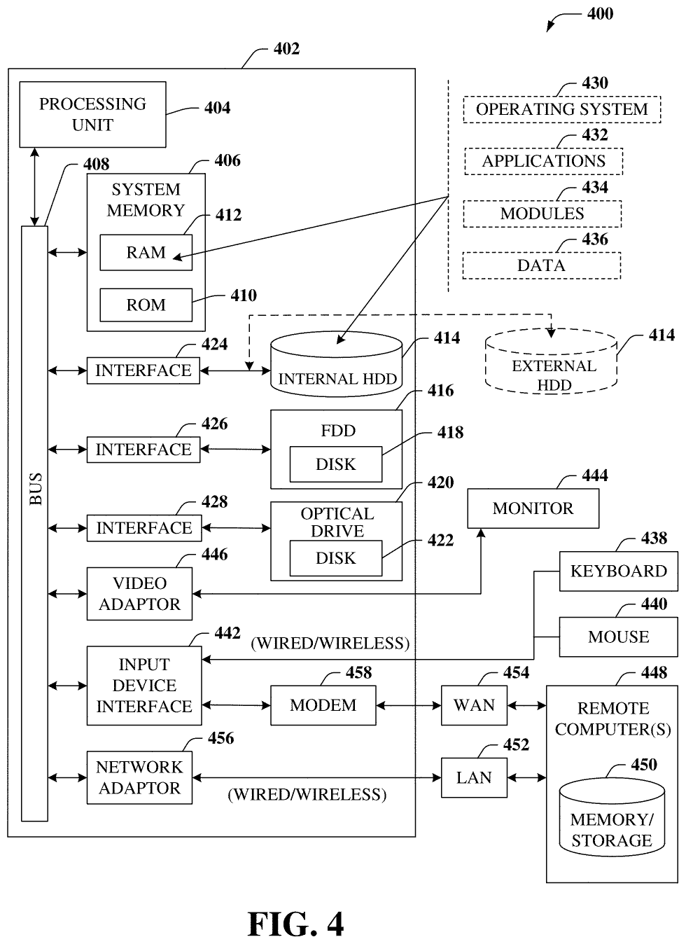

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part personalizing content items such as advertisements for presentation to a user, based on social content and other online information of the user.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in other embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

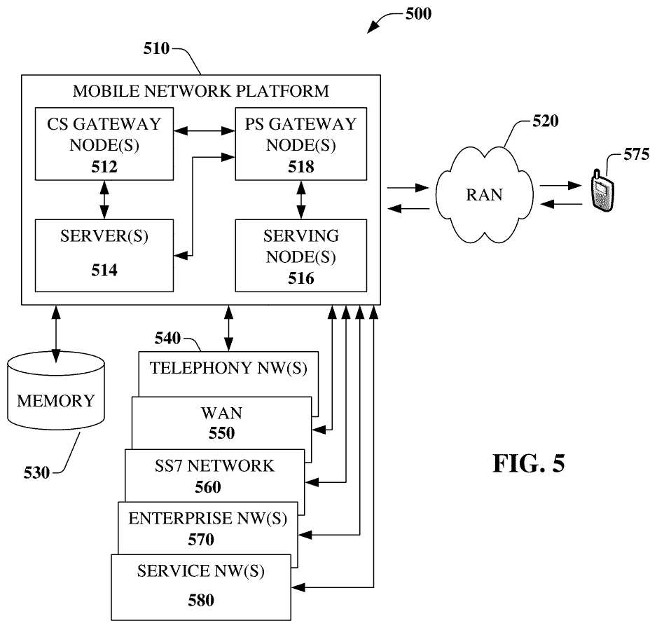

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part personalizing content items such as advertisements for presentation to a user, based on social content and other online information of the user. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

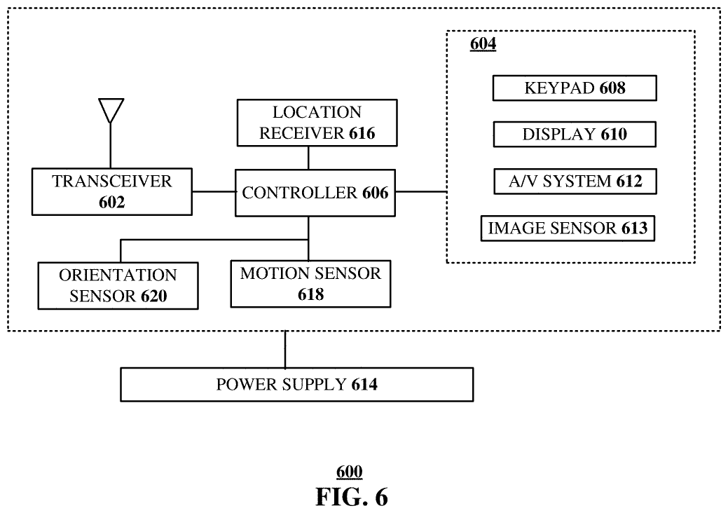

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part personalizing content items such as advertisements for presentation to a user, based on social content and other online information of the user.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. In other embodiments, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving an anchor media item;
receiving social network information of a user;
creating a profile for the user based on the social network information of the user;
modifying the anchor media item using the profile for the user to personalize the anchor media item for the user, forming a personalized media item;
presenting the personalized media item over a network to a user device associated with the user;
detecting a response to the personalized media item by the user following the presenting the personalized media item to the user; and
updating the profile for the user responsive to detecting the response.

2. The device of claim 1, wherein the operations further comprise:
reusing the profile for the user to modify a subsequent media item, forming a subsequent personalized media item; and
presenting the subsequent personalized media item to the user device associated with the user.

3. The device of claim 2, wherein the operations further comprise:
receiving the subsequent media item from an anchor data marketplace;
modifying the subsequent media item using the social network information of the user to personalize the subsequent media item for the user, forming the subsequent personalized media item; and
presenting the subsequent personalized media item over the network to the user device.

4. The device of claim 1, wherein the operations further comprise:
retrieving a plurality of anchor media items including the anchor media item from an anchor data marketplace; and
determining respective affinities between the user and respective anchor media items of the plurality of anchor media items.

5. The device of claim 4, wherein the operations further comprise:
mapping each anchor media item of the plurality of anchor media items to an embedding vector space;
mapping a plurality of users including the user to the vector space based on interests of the plurality of users determined from social network information of the users including the social network information of the user;
determining distances between the respective media items in the vector space and the user in the vector space; and
determining the respective affinities based on the Cartesian distances.

6. The device of claim 1, wherein the receiving the social network information of the user comprises:
receiving information about social media activity of the user; and
receiving information about online activity of the user.

7. The device of claim 1, wherein the modifying the anchor media item using the profile for the user to personalize the anchor media item for the user comprises:
receiving a video file from an anchor data marketplace, wherein the video file forms a part of the anchor media item;
identifying an anchor face in the video file; and
mapping a face from the profile for the user to the anchor face identified in the video file to personalize the anchor media item for the user.

8. The device of claim 7, wherein the mapping the face from the profile for the user to the anchor face comprises mapping a composite face formed from images of faces of online acquaintances of the user.

9. A method, comprising:
receiving, by a processing system including a processor, a request for personalized media content for presentation on a user device of a user;
selecting, by the processing system, from an anchor media marketplace, an anchor media item for the personalized media content;
retrieving, by the processing system, information defining a derived persona of the user;
personalizing, by the processing system, the anchor media item according to the derived persona of the user, forming a personalized media item; and
presenting, by the processing system, the personalized media item to the user device of the user, wherein the presenting is substantially in real time with the receiving the request for the personalized media content.

10. The method of claim 9, wherein the personalizing the anchor media item comprises:
modifying, by the processing system, the anchor media item using the derived persona of the user to increase affinity of the user for the anchor media item or a product advertised in the anchor media item.

11. The method of claim 9, wherein the personalizing the anchor media item comprises:
receiving, by the processing system, a video file from the anchor media marketplace, wherein the video file forms a part of the anchor media item;
identifying, by the processing system, an anchor face in the video file;
mapping, by the processing system, a face from the derived persona of the user to the anchor face identified in the video file to personalize the anchor media item for the user; and
optically blending, by the processing system, transition regions between the face from the derived persona of the user and the anchor face.

12. The method of claim 11, further comprising:
determining, by the processing system, one or more constraints specified for the video file in the anchor media marketplace; and
limiting, by the processing system, usage of the video file with the personalized media item according to the one or more constraints.

13. The method of claim 9, further comprising:
receiving, by a processing system including a processor, a subsequent request for additional personalized media content from the anchor media marketplace for presentation on an other user device; and
reusing, by the processing system, from the anchor media marketplace, the anchor media item for the additional personalized media content on the other user device.

14. The method of claim 9, wherein the selecting an anchor media item for the personalized media content comprises:
selecting, by the processing system, a preexisting media item for modification according to the derived persona of the user without re-shooting the preexisting media item.

15. The method of claim 9, further comprising:
collecting, by the processing system, social media information of the user;
collecting, by the processing system, online information of the user;
computing, by the processing system, the derived persona of the user, wherein the computer the derived persona is based on the social media information of the user and the online information of the user; and
storing, by the processing system, for subsequent use, the information defining the derived persona of the user.

16. The method of claim 15, wherein computing the derived persona of the user comprises:
receiving, by the processing system, social media information of the user;
detecting, by the processing system, a plurality of descriptors for the user, wherein the detecting the plurality of descriptors comprises detecting the plurality of descriptors in the social media information of the user;
determining, by processing system, a plurality of weights for the anchor media item; and
modifying the anchor media item according to the plurality of weights for the anchor media item and the plurality of descriptors to produce personalized media item.

17. A non-transitory, machine-readable medium, comprising executable instructions that, when executed by a processing system including a processor, facilitate performance of operations, the operations comprising:
storing, in an anchor data marketplace, content items for modification to create one or more personalized content items;
receiving a request for a personalized content item, the personalized content item to be provided to a user device of a user;
selecting, from the anchor data marketplace a selected content item;
determining one or more constraints for the selected content item, the one or more constraints including information limiting use or reuse of the selected content item;
comparing the one or more constraints for the selected content item with the request for the personalized content item;
modifying the selected content item if the selected content item is usable according to the one or more constraints, wherein the modifying the selected content item comprises personalizing the selected content item according to stored personalization information of the user, to produce the personalized content item; and
providing the personalized content item to the user device of the user.

18. The non-transitory, machine-readable medium of claim 17, wherein the personalizing the selected content item according to stored personalization information of the user comprises:
identifying one or more human faces appearing in the selected content item;
retrieving from storage information about a derived persona of the user; and
modifying appearance of the one or more human faces according to the derived persona of the user to increase affinity of the user for the personalized content item.

19. The non-transitory, machine-readable medium of claim 17, wherein the operations further comprise:
determining relative affinities of a plurality of users including the user with the content items in the anchor data marketplace; and
selecting the selected content item from the anchor data marketplace based on a relative affinity for the user with the selected content item.

20. The non-transitory, machine-readable medium of claim 19, wherein the operations further comprise:
mapping each content item in the anchor data marketplace to a vector space;
determining social network information of the plurality of users;
mapping the plurality of users including the user to the vector space based on interests of the plurality of users determined from the social network information of the plurality of users;
determining distances in the vector space between the content items in the vector space and the plurality of users in the vector space; and
determining the relative affinities of the plurality of users based on the distances in the vector space.
